(19) United States
(12) Patent Application Publication
(10) Pub. No.: US 2008/0240257 A1
(43) Pub. Date: Oct. 2, 2008

(54) Using quantization bias that accounts for relations between transform bins and quantization bins

(75) Inventors: Cheng Chang, Redmond, WA (US); Thomas W. Holcomb, Bothell, WA (US); Chih-Lung Lin, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/728,702

(22) Filed: Mar. 26, 2007

(51) Int. Cl. H04B 1/66

(52) U.S. Cl. 375/241

(57) ABSTRACT

Techniques and tools are described for using quantization bias that accounts for relations between transform bins and quantization bins. The techniques and tools can be used to compensate for mismatch between transform bin boundaries and quantization bin boundaries during quantization. For example, in some embodiments, when a video encoder quantizes the DC coefficients of DC-only blocks, the encoder compensates for mismatches between transform bin boundaries and quantization bin boundaries. In some implementations, the mismatch compensation uses an offset table that accounts for the mismatches. In other embodiments, the encoder uses adjustable thresholds to control quantization bias.

### BACKGROUND

Digital video consumes large amounts of storage and transmission capacity. Many computers and computer networks lack the resources to process raw digital video. For this reason, engineers use compression (also called coding or encoding) to reduce the bit rate of digital video. Compression decreases the cost of storing and transmitting video by converting the video into a lower bit rate form. Decompression (also called decoding) reconstructs a version of the original video from the compressed form. A “codec” is an encoder/decoder system.

Compression can be lossless, in which the quality of the video does not suffer, but decreases in bit rate are limited by the inherent amount of variability (sometimes called entropy) of the video data. Or, compression can be lossy, in which the quality of the video suffers, but achievable decreases in bit rate are more dramatic. Lossy compression is often used in conjunction with lossless compression—the lossy compression establishes an approximation of information, and the lossless compression is applied to represent the approximation.

A basic goal of lossy compression is to provide good rate-distortion performance. So, for a particular bit rate, an encoder attempts to provide the highest quality of video. Or, for a particular level of quality/fidelity to the original video, an encoder attempts to provide the lowest bit rate encoded video. In practice, considerations such as encoding time, encoding complexity, encoding resources, decoding time, decoding complexity, decoding resources, overall delay, and/or smoothness in quality/bit rate changes also affect decisions made in codec design as well as decisions made during actual encoding.

In general, video compression techniques include “intra-picture” compression and “inter-picture” compression. Intra-picture compression techniques compress an individual picture, and inter-picture compression techniques compress a picture with reference to a preceding and/or following picture (often called a reference or anchor picture) or pictures.

### I. Intra and Inter Compression.

FIG. 1 illustrates block-based intra compression in an example encoder. In particular, FIG. 1 illustrates intra compression of an 8×8 block (105) of samples by the encoder. The encoder splits a picture into 8×8 blocks of samples and applies a forward 8×8 frequency transform (110) (such as a discrete cosine transform (“DCT”)) to individual blocks such as the block (105). The frequency transform (110) maps the sample values to transform coefficients, which are coefficients of basis functions that correspond to frequency components. In typical encoding scenarios, a relatively small number of frequency coefficients capture much of the energy or signal content in video. In theory, conversions between sample values are transform coefficients can be lossless, but in practice, rounding and limitations on precision can introduce error.

The encoder quantizes (120) the transform coefficients (115), resulting in an 8×8 block of quantized transform coefficients (125). With quantization, the encoder essentially trades off quality and bit rate. More specifically, quantization can affect the fidelity with which the transform coefficients are encoded, which in turn can affect bit rate. Coarser quantization tends to decrease fidelity to the original transform coefficients as the coefficients are more coarsely approximated. Bit rate also decreases, however, when decreased complexity can be exploited with lossless compression. Conversely, finer quantization tends to preserve fidelity and quality but result in higher bit rates. Different encoders use different parameters for quantization. In most encoders, a level or step size of quantization is set for a block, picture, or other unit of video. Some encoders quantize coefficients differently within a given block, so as to apply relatively coarser quantization to perceptually less important coefficients, and a quantization matrix can be used to indicate the relative quantization weights. Or, apart from the rules used to reconstruct quantized values, some encoders vary the thresholds according to which values are quantized so as to quantize certain values more aggressively than others.

Returning to FIG. 1, further encoding varies depending on whether a coefficient is a DC coefficient (the lowest frequency coefficient shown as the top left coefficient in the block (125)), an AC coefficient in the top row or left column in the block (125), or another AC coefficient. The encoder typically encodes the DC coefficient (126) as a differential from the reconstructed DC coefficient (136) of a neighboring 8×8 block. The encoder entropy encodes (140) the differential. The entropy encoder can encode the left column or top row of AC coefficients as differentials from AC coefficients a corresponding left column or top row of a neighboring 8×8 block. The encoder scans (150) the 8×8 block (145) of predicted, quantized AC coefficients into a one-dimensional array (155). The encoder then entropy encodes the scanned coefficients using a variation of run/level coding (160).

In corresponding decoding, a decoder produces a reconstructed version of the original 8×8 block. The decoder entropy decodes the quantized transform coefficients, scanning the quantized coefficients into a two-dimensional block, and performing AC prediction and/or DC prediction as needed. The decoder inverse quantizes the quantized transform coefficients of the block and applies an inverse frequency transform (such as an inverse DCT (“IDCT”)) to the de-quantized transform coefficients, producing the reconstructed version of the original 8×8 block. When a picture is used as a reference picture in subsequent motion compensation (see below), an encoder also reconstructs the picture.

Inter-picture compression techniques often use motion estimation and motion compensation to reduce bit rate by exploiting temporal redundancy in a video sequence. Motion estimation is a process for estimating motion between pictures. In general, motion compensation is a process of reconstructing pictures from reference picture(s) using motion data, producing motion-compensated predictions.

For a current unit (e.g., 8×8 block) being encoded, the encoder computes the sample-by-sample difference between the current unit and its motion-compensated prediction to determine a residual (also called error signal). The residual is frequency transformed, quantized, and entropy encoded. For example, for a current 8×8 block of a predicted picture, an encoder computes an 8×8 prediction error block as the difference between a motion-predicted block and the current 8×8 block. The encoder applies a frequency transform to the residual, producing a block of transform coefficients. Some encoders switch between different sizes of transforms, e.g., an 8×8 transform, two 4×8 transforms, two 8×4 transforms, or four 4×4 transforms for an 8×8 prediction residual block. The encoder quantizes the transform coefficients and scans the quantized coefficients into a one-dimensional array such that coefficients are generally ordered from lowest frequency to highest frequency. The encoder entropy codes the data in the array.

If a predicted picture is used as a reference picture for subsequent motion compensation, the encoder reconstructs the predicted picture. When reconstructing residuals, the encoder reconstructs transform coefficients that were quantized and performs an inverse frequency transform. The encoder performs motion compensation to compute the motion-compensated predictors, and combines the predictors with the residuals. During decoding, a decoder typically entropy decodes information and performs analogous operations to reconstruct residuals, perform motion compensation, and combine the predictors with the reconstructed residuals.

### II. Quantization Artifacts for DC-Only Blocks.

In some cases, when a block of input values is frequency transformed, only the DC coefficient for the block has a significant value. This might be the case, for example, if sample values for the block are uniform or nearly uniform, with the DC coefficient indicating the average of the sample values and the AC coefficients being zero or having small values that become zero after quantization. Using DC-only blocks facilitates compression in many cases, but can result in perceptible quantization artifacts in the form of step-wise boundaries between blocks.

FIG. 2 illustrates quantization artifacts that appear when four adjacent 8×8 blocks (210) having fairly uniform sample values are compressed as DC-only blocks. Suppose each of the 8×8 blocks (210) has 64 samples with values of 16 or 17. The upper left block and lower right block each have thirty-nine 17s and twenty-five 16s, for an average value of 16.61. The upper right block and lower left block each have thirty-seven 17s and twenty-seven 16s, for an average value of 16.58. The sample values for each of the blocks (210) are frequency-transformed, and the transform coefficients are quantized. During decoding, the transform coefficients are reconstructed by inverse quantization, and the reconstructed transform coefficients are inverse transformed. Since the average input values are 16.58 and 16.61, and the blocks (210) are compressed as DC-only blocks, one might expect each of the blocks (210) to be reconstructed as a uniform block of samples with a value of 17, rounding up from 16.58 or 16.61. This happens for some levels of quantization. For other levels of quantization, however, some of the reconstructed blocks (220) have different values than the others, being reconstructed as a uniform block of samples with a value of 16. This creates perceptible blocking artifacts between the reconstructed blocks (220) due to the step-wise changes in sample values between the blocks.

Blocks with nearly even proportions or gradually changing proportions of closely related values appear naturally in some video sequences. Such blocks can also result from certain common preprocessing operations like dithering on source video sequences. For example, when a source video sequence that includes pictures with 10-bit samples (or 12-bit) samples is converted to a sequence with 8-bit samples, the number of bits used to represent each sample is reduced from 10 bits (or 12 bits) to 8 bits. As a result, regions of gradually varying brightness or color in the original source video might appear unrealistically uniform in the sequence with 8-bit samples, or they might appear to have bands or steps instead of the gradations in brightness or color. Prior to distribution, the producer of the source video might therefore use dithering to introduce texture in the image or smooth noticeable bands or steps. The dithering makes minor up/down adjustments to sample values to break up monotonous regions or bands/steps, making the source video look more realistic since the human eye “averages” the fine detail.

For example, if 10-bit sample values gradually change from 16.25 to 16.75 in a region, steps may appear when the 10-bit sample values are converted to 8-bit values. To smooth the steps, dithering adds an increasing proportion of 17 values to the 16-value step and adds a decreasing proportion of 16 values to the 17-value step. This helps improve perceptual quality of the source video, but subsequent compression may introduce unintended blocking artifacts.

During compression, if the dithered regions are represented with DC-only blocks, blocking artifacts may be especially noticeable. If dithering can be disabled, that may help. In many cases, however, the dithering is performed long before the video is available for compression, and before the encoding decisions that might classify blocks as DC-only blocks in a particular encoding scenario.

### SUMMARY

In summary, the detailed description presents techniques and tools for improving quantization. For example, a video encoder quantizes DC coefficients of DC-only blocks in ways that tend to reduce blocking artifacts for those blocks, which improves perceptual quality.

In some embodiments, a tool such as a video encoder receives input values. The input values can be sample values for an image, residual values for an image, or some other type of information. The tool produces transform coefficient values by performing a frequency transform on the input values. The tool then quantizes the transform coefficient values. For example, the tool sets a quantization level for a DC coefficient value of a DC-only block.

In setting the quantization level for a coefficient value, the tool uses quantization bias that accounts for relations between quantization bins and transform bins. Generally, a quantization bin for coefficient values includes those coefficient values that, following quantization and inverse quantization by a particular quantization step size, have the same reconstructed coefficient value. A transform bin in general includes those coefficient values that, following inverse frequency transformation, yield a particular input-domain value (or at least influence the inverse frequency transform to yield that value). The boundaries of quantization bins often are not aligned with the boundaries of transform bins. This mismatch can result in blocking artifacts such as described above with reference to FIG. 2, if a coefficient value that originally falls in a first transform bin instead falls in a second transform bin after quantization and inverse quantization of the coefficient value. By accounting for boundary misalignments, the tool can compensate for the mismatch. Or, the tool can bias the quantization of coefficient values for reasons other than mismatch compensation. For example, accounting for the relations between quantization bins and transform bins, the tool can bias the quantization of coefficient values according to a threshold set or adjusted to reduce blocking artifacts when dithered content is encoded as DC-only blocks.

In some implementations, the tool uses one or more offset tables when performing mismatch compensation. For example, the offset tables store offsets for possible DC coefficient values at different quantization step sizes. When quantizing a particular DC coefficient value at a particular quantization step size, the tool looks up an offset and, if appropriate, adjusts the quantization level for the DC coefficient value using the offset. When the offsets have a periodic pattern, offset table size can be reduced to save storage and memory.

In other implementations, the tool exposes an adjustable parameter that controls the extent of quantization bias. For example, the parameter is adjustable by a user or adjustable by the tool. The parameter can be adjusted before encoding or during encoding in reaction to results of previous encoding. Although the parameter can be set such that the tool performs mismatch compensation, it can more generally be set or adjusted to bias quantization as deemed appropriate. For example, the parameter can be set or adjusted to reduce blocking artifacts that mismatch compensation would not reduce.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram showing encoding of a block with intra-picture compression according to the prior art.

FIG. 2 is a diagram illustrating a type of quantization artifact according to the prior art.

FIG. 3 is a block diagram of a suitable computing environment in which several described embodiments may be implemented.

FIG. 4 is a block diagram of a video encoder system in conjunction with which several described embodiments may be implemented.

FIG. 5 is a diagram illustrating mismatches between transform bin boundaries and quantization bin boundaries.

FIG. 6 is a flowchart showing a generalized technique for using quantization bias that accounts for relations between transform bins and quantization bins.

FIG. 7 is a flowchart showing a technique for mismatch compensation using sample domain comparisons in quantization of DC coefficients.

FIG. 8 is a flowchart showing a technique for mismatch compensation using transform domain comparisons in quantization of DC coefficients.

FIG. 9 is a flowchart showing a technique for mismatch compensation using predetermined offset tables in quantization of DC coefficients.

FIG. 10 is a block diagram showing a tool that computes values of offset tables used for mismatch compensation of DC coefficients.

FIG. 11 is a flowchart showing a technique for DC coefficient compensation using adjustable bias thresholds.

FIG. 12 is a pseudocode listing illustrating one implementation of the technique for DC coefficient compensation using adjustable bias thresholds.

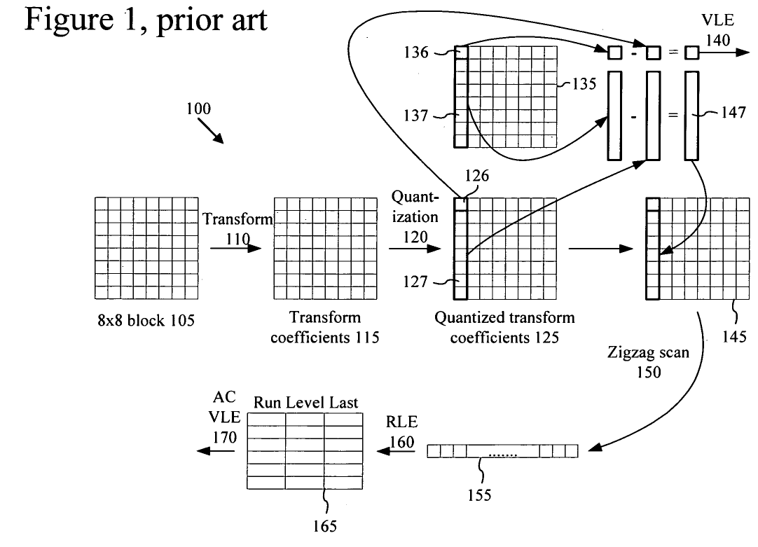

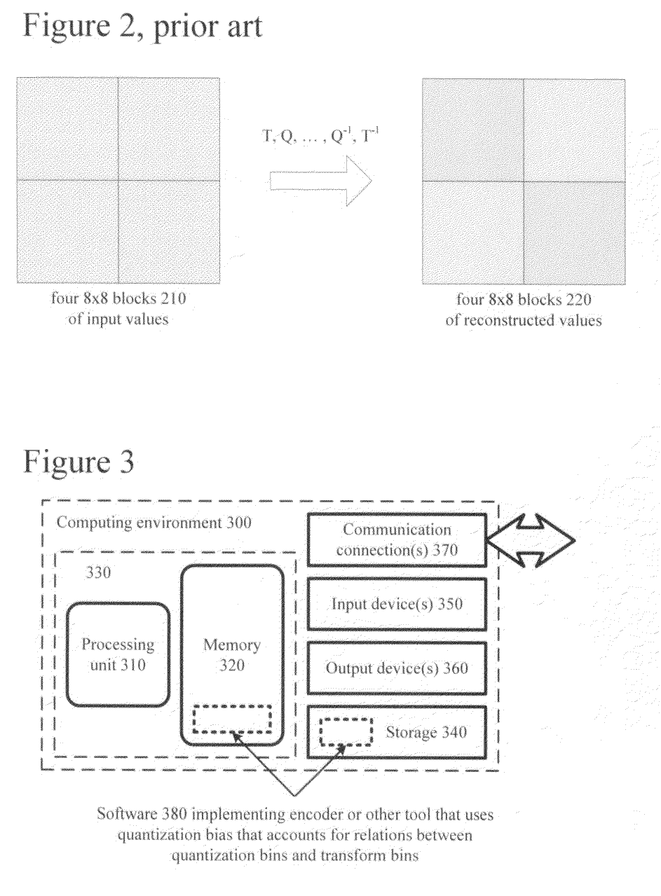

### DETAILED DESCRIPTION

The present application relates to techniques and tools for improving quantization by using quantization bias that accounts for relations between quantization bins and transform bins. The techniques and tools can be used to compensate for mismatch between transform bin boundaries and quantization bin boundaries during quantization. For example, in some embodiments, when a video encoder quantizes the DC coefficients of DC-only blocks, the encoder uses mismatch compensation to reduce or even eliminate quantization artifacts caused by such mismatches. The quantization artifacts caused by mismatches may occur in video that includes naturally uniform patches, or they may occur when video is converted to a lower sample depth and dithered. How the encoder compensates for mismatches can be predefined and specified in offset tables.

In other embodiments, an adjustable threshold controls the extent of quantization bias. For example, the amount of bias can be adjusted by software depending on whether blocking artifacts are detected by the software. Or, someone who controls encoding during video production can adjust the amount of bias to reduce perceptible blocking artifacts in a scene, image, or part of an image. When a dithered region is encoded, for example, presenting the region with a single color might be preferable to presenting the region with blocking artifacts.

Various alternatives to the implementations described herein are possible. For example, certain techniques described with reference to flowchart diagrams can be altered by changing the ordering of stages shown in the flowcharts, by repeating or omitting certain stages, etc. The various techniques and tools described herein can be used in combination or independently. Different embodiments implement one or more of the described techniques and tools. Aside from uses in video compression, the quantization bias techniques and tools can be used in image compression, audio compression, other compression, or other areas. Moreover, while many examples described herein involve quantization of DC coefficients for DC-only blocks, alternatively the techniques and tools described herein are applied to quantization of DC coefficients for other blocks, or to quantization of AC coefficients.

Some of the techniques and tools described herein address one or more of the problems noted in the Background. Typically, a given technique/tool does not solve all such problems. Rather, in view of constraints and tradeoffs in encoding time, resources, and/or quality, the given technique/tool improves encoding performance for a particular implementation or scenario.

### I. Computing Environment.

FIG. 3 illustrates a generalized example of a suitable computing environment (300) in which several of the described embodiments may be implemented. The computing environment (300) is not intended to suggest any limitation as to scope of use or functionality, as the techniques and tools may be implemented in diverse general-purpose or special-purpose computing environments.

With reference to FIG. 3, the computing environment (300) includes at least one processing unit (310) and memory (320). In FIG. 3, this most basic configuration (330) is included within a dashed line. The processing unit (310) executes computer-executable instructions and may be a real or a virtual processor. In a multi-processing system, multiple processing units execute computer-executable instructions to increase processing power. The memory (320) may be volatile memory (e.g., registers, cache, RAM), non-volatile memory (e.g., ROM, EEPROM, flash memory, etc.), or some combination of the two. The memory (320) stores software (380) implementing an encoder with one or more of the described techniques and tools for using quantization bias that accounts for relations between quantization bins and transform bins.

A computing environment may have additional features. For example, the computing environment (300) includes storage (340), one or more input devices (350), one or more output devices (360), and one or more communication connections (370). An interconnection mechanism (not shown) such as a bus, controller, or network interconnects the components of the computing environment (300). Typically, operating system software (not shown) provides an operating environment for other software executing in the computing environment (300), and coordinates activities of the components of the computing environment (300).

The storage (340) may be removable or non-removable, and includes magnetic disks, magnetic tapes or cassettes, CD-ROMs, DVDs, or any other medium which can be used to store information and which can be accessed within the computing environment (300). The storage (340) stores instructions for the software (380) implementing the video encoder.

The input device(s) (350) may be a touch input device such as a keyboard, mouse, pen, or trackball, a voice input device, a scanning device, or another device that provides input to the computing environment (300). For audio or video encoding, the input device(s) (350) may be a sound card, video card, TV tuner card, or similar device that accepts audio or video input in analog or digital form, or a CD-ROM or CD-RW that reads audio or video samples into the computing environment (300). The output device(s) (360) may be a display, printer, speaker, CD-writer, or another device that provides output from the computing environment (300).

The communication connection(s) (370) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment (300), computer-readable media include memory (320), storage (340), communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “find” and “select” to describe computer operations in a computing environment. These terms are high-level abstractions for operations performed by a computer, and should not be confused with acts performed by a human being. The actual computer operations corresponding to these terms vary depending on implementation.

### II. Generalized Video Encoder.

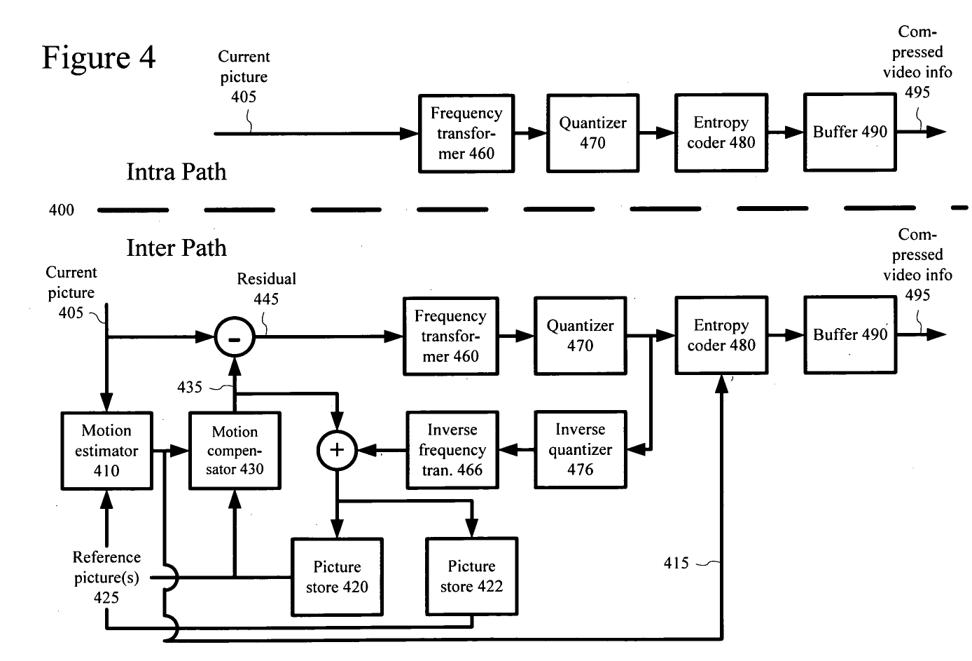

FIG. 4 is a block diagram of a generalized video encoder (400) in conjunction with which some described embodiments may be implemented. The encoder (400) receives a sequence of video pictures including a current picture (405) and produces compressed video information (495) as output to storage, a buffer, or a communications connection. The format of the output bitstream can be a Windows Media Video or VC-1 format, MPEG-x format (e.g., MPEG-1, MPEG-2, or MPEG-4), H.26x format (e.g., H.261, H.262, H.263, or H.264), or other format.

The encoder (400) processes video pictures. The term picture generally refers to source, coded or reconstructed image data. For progressive video, a picture is a progressive video frame. For interlaced video, a picture may refer to an interlaced video frame, the top field of the frame, or the bottom field of the frame, depending on the context. The encoder (400) is block-based and uses a 4:2:0 macroblock format for frames, with each macroblock including four 8×8 luminance blocks (at times treated as one 16×16 macroblock) and two 8×8 chrominance blocks. For fields, the same or a different macroblock organization and format may be used. The 8×8 blocks may be further sub-divided at different stages, e.g., at the frequency transform and entropy encoding stages. The encoder (400) can perform operations on sets of samples of different size or configuration than 8×8 blocks and 16×16 macroblocks. Alternatively, the encoder (400) is object-based or uses a different macroblock or block format.

Returning to FIG. 4, the encoder system (400) compresses predicted pictures and intra-coded, key pictures. For the sake of presentation, FIG. 4 shows a path for key pictures through the encoder system (400) and a path for predicted pictures. Many of the components of the encoder system (400) are used for compressing both key pictures and predicted pictures. The exact operations performed by those components can vary depending on the type of information being compressed.

A predicted picture (e.g., progressive P-frame or B-frame, interlaced P-field or B-field, or interlaced P-frame or B-frame) is represented in terms of prediction from one or more other pictures (which are typically referred to as reference pictures or anchors). A prediction residual is the difference between predicted information and corresponding original information. In contrast, a key picture (e.g., progressive I-frame, interlaced I-field, or interlaced I-frame) is compressed without reference to other pictures.

If the current picture (405) is a predicted picture, a motion estimator (410) estimates motion of macroblocks or other sets of samples of the current picture (405) with respect to one or more reference pictures. The picture store (420) buffers a reconstructed previous picture (425) for use as a reference picture. When multiple reference pictures are used, the multiple reference pictures can be from different temporal directions or the same temporal direction. The motion estimator (410) outputs as side information motion information (415) such as differential motion vector information.

The motion compensator (430) applies reconstructed motion vectors to the reconstructed (reference) picture(s) (425) when forming a motion-compensated current picture (435). The difference (if any) between a block of the motion-compensated current picture (435) and corresponding block of the original current picture (405) is the prediction residual (445) for the block. During later reconstruction of the current picture, reconstructed prediction residuals are added to the motion compensated current picture (435) to obtain a reconstructed picture that is closer to the original current picture (405). In lossy compression, however, some information is still lost from the original current picture (405). Alternatively, a motion estimator and motion compensator apply another type of motion estimation/compensation.

A frequency transformer (460) converts spatial domain video information into frequency domain (i.e., spectral, transform) data. For block-based video pictures, the frequency transformer (460) applies a DCT, variant of DCT, or other forward block transform to blocks of the samples or prediction residual data, producing blocks of frequency transform coefficients. Alternatively, the frequency transformer (460) applies another conventional frequency transform such as a Fourier transform or uses wavelet or sub-band analysis. The frequency transformer (460) may apply an 8×8, 8×4, 4×8, 4×4 or other size frequency transform.

A quantizer (470) then quantizes the blocks of transform coefficients. The quantizer (470) applies uniform, scalar quantization to the spectral data with a step size that varies on a picture-by-picture basis or other basis. The quantizer (470) can also apply another type of quantization to the spectral data coefficients, for example, a non-uniform or non-adaptive quantization. In described embodiments, the quantizer (470) biases quantization in ways that account for relations between transform bins and quantization bins, for example, compensating for mismatch between transform bin boundaries and quantization bin boundaries.

When a reconstructed current picture is needed for subsequent motion estimation/compensation, an inverse quantizer (476) performs inverse quantization on the quantized spectral data coefficients. An inverse frequency transformer (466) performs an inverse frequency transform, producing blocks of reconstructed prediction residuals (for a predicted picture) or samples (for a key picture). If the current picture (405) was a key picture, the reconstructed key picture is taken as the reconstructed current picture (not shown). If the current picture (405) was a predicted picture, the reconstructed prediction residuals are added to the motion-compensated predictors (435) to form the reconstructed current picture. One or both of the picture stores (420, 422) buffers the reconstructed current picture for use in subsequent motion-compensated prediction.

The entropy coder (480) compresses the output of the quantizer (470) as well as certain side information (e.g., motion information (415), quantization step size). Typical entropy coding techniques include arithmetic coding, differential coding, Huffman coding, run length coding, LZ coding, dictionary coding, and combinations of the above. The entropy coder (480) typically uses different coding techniques for different kinds of information, and can choose from among multiple code tables within a particular coding technique.

The entropy coder (480) provides compressed video information (495) to the multiplexer (“MUX”) (490). The MUX (490) may include a buffer, and a buffer level indicator may be fed back to a controller. Before or after the MUX (490), the compressed video information (495) can be channel coded for transmission over the network.

A controller (not shown) receives inputs from various modules such as the motion estimator (410), frequency transformer (460), quantizer (470), inverse quantizer (476), entropy coder (480), and buffer (490). The controller evaluates intermediate results during encoding, for example, setting quantization step sizes and performing rate-distortion analysis. The controller works with modules such as the motion estimator (410), frequency transformer (460), quantizer (470), and entropy coder (480) to set and change coding parameters during encoding. When an encoder evaluates different coding parameter choices during encoding, the encoder may iteratively perform certain stages (e.g., quantization and inverse quantization) to evaluate different parameter settings. The encoder may set parameters at one stage before proceeding to the next stage. For example, the encoder may decide whether a block should be treated as a DC-only block, and then quantize the DC coefficient value for the block. Or, the encoder may jointly evaluate different coding parameters. The tree of coding parameter decisions to be evaluated, and the timing of corresponding encoding, depends on implementation.

The relationships shown between modules within the encoder (400) indicate general flows of information in the encoder; other relationships are not shown for the sake of simplicity. In particular, FIG. 4 usually does not show side information indicating the encoder settings, modes, tables, etc. used for a video sequence, picture, macroblock, block, etc. Such side information, once finalized, is sent in the output bitstream, typically after entropy encoding of the side information.

Particular embodiments of video encoders typically use a variation or supplemented version of the generalized encoder (400). Depending on implementation and the type of compression desired, modules of the encoder can be added, omitted, split into multiple modules, combined with other modules, and/or replaced with like modules. For example, the controller can be split into multiple controller modules associated with different modules of the encoder. In alternative embodiments, encoders with different modules and/or other configurations of modules perform one or more of the described techniques.

III. Using Quantization Bias that Accounts for Relations Between Quantization Bins and Transform Bins.

The present application describes techniques and tools for biasing quantization in ways that account for the relations between quantization bins and transform bins. For example, an encoder biases quantization using a pre-defined threshold to compensate for mismatch between transform bin boundaries and quantization bin boundaries during quantization. Mismatch compensation (also called misalignment compensation) can help the encoder reduce or avoid certain types of perceptual artifacts that occur during encoding. Or, an encoder adjusts a threshold used to control quantization bias so as to reduce blocking artifacts for certain kinds of content, e.g., dithered content.

A. Theory and Explanation.

During encoding, a frequency transform converts a block of input values to frequency transform coefficients. The transform coefficients include a DC coefficient and AC coefficients. Ultimately, for reconstruction during encoding or decoding, an inverse frequency transform converts the transform coefficients back to input values.

Transform coefficient values are usually quantized after the forward transform so as to control quality and bit rate. When the coefficient values are quantized, they are represented with quantization levels. During reconstruction, the quantized coefficient values are inverse quantized. For example, the quantization level representing a given coefficient value is reconstructed to a corresponding reconstruction point value. Due to the effects of quantization, the inverse frequency transform converts the inverse quantized transform coefficients (reconstruction point values) to approximations of the input values. In theory, the same approximations of the input values could be obtained by shifting the original transform coefficients to the respective reconstruction points then performing the inverse frequency transform, still accounting for the effects of quantization.

In some scenarios, encoders represent blocks of input values as DC-only blocks. For a DC-only block, the DC coefficient has a non-zero value and the AC coefficients are zero or quantized to zero. For DC-only blocks, the possible values of DC coefficients can be separated into transform bins. For example, suppose that for a forward transform, any input block having an average value x̅ produces an integer DC coefficient value X in the range of:
DCₐ≦X<DC_{b} if a≦ x̅<b,
DC_{b}≦X<DC_{c} if b≦ x̅<c,
DC_{c}≦X<DC_{d} if c≦ x̅<d, and so on.
   For a DC-only block, DCₐ≦X<DC_{b} is a transform bin for coefficient values that will be reconstructed to the input value halfway between a and b. DC_{b}≦X<DC_{c} and DC_{c}≦X<DC_{d} are adjacent transform bins. The boundaries (at DC_{b}, at DC_{c}) between the transform bins are examples of transform bin boundaries.

In quantization a DC coefficient value is replaced with a quantization level, and in inverse quantization the quantization level is replaced with a reconstruction point value. For some quantization step sizes and DC coefficient values, the original DC coefficient value and reconstruction point value are on different sides of a transform bin boundary, which can result in perceptual artifacts for DC-only blocks. For example, suppose for a particular quantization step size that any DC coefficient value in the range of:
DC_{σ}≦X<DC_{ζ} is assigned a quantization level that has a reconstruction point halfway between DC_{σ} and DC_{ζ},
DC_{ζ}≦X<DC_{τ} is assigned a quantization level that has a reconstruction point halfway between DC_{ζ} and DC_{τ},
DC_{τ}≦X<DC_{υ} is assigned a quantization level that has a reconstruction point halfway between DC_{τ} and DC_{υ}, and so on.
   DC_{σ}≦X<DC_{ζ}, DC_{ζ}≦X<DC_{τ} and DC_{τ}≦X<DC_{υ} are quantization bins. The boundaries (at DC_{ζ}, at DC_{τ}) between the quantization bins are examples of quantization bin boundaries. Different quantization step sizes result in different sets of quantization bins, and quantization bin boundaries typically do not align with transform bin boundaries.

So, a particular DC coefficient value on one side of a transform bin boundary can be quantized to a quantization level that has a reconstruction point value on the other side of the transform bin boundary. This happens when the original DC coefficient value is closer to that reconstruction point value than it is to the reconstruction point value on its other side. After the inverse transform, however, the reconstructed input values may deviate from expected reconstructed values if the DC coefficient value has switched sides of a transform bin boundary.

1. Example Forward and Inverse Frequency Transforms.

The quantization bias and mismatch compensation techniques described herein can be implemented for various types of frequency transforms. For example, in some implementations, the techniques described herein are used in an encoder that performs frequency transforms for 8×8, 4×8, 8×4 or 4×4 blocks using the following matrices and rules.

$${T}_{8} = [ \begin{matrix}12 & 12 & 12 & 12 & 12 & 12 & 12 & 12 \\ 16 & 15 & 9 & 4 & - 4 & - 9 & - 15 & - 16 \\ 16 & 6 & - 6 & - 16 & - 16 & - 6 & 6 & 16 \\ 15 & - 4 & - 16 & - 9 & 9 & 16 & 4 & - 15 \\ 12 & - 12 & - 12 & 12 & 12 & - 12 & - 12 & 12 \\ 9 & - 16 & 4 & 15 & - 15 & - 4 & 16 & - 9 \\ 6 & - 16 & 16 & - 6 & - 6 & 16 & - 16 & 6 \\ 4 & - 9 & 15 & - 16 & 16 & - 15 & 9 & - 4\end{matrix} ] . \\ {T}_{4} = [ \begin{matrix}17 & 17 & 17 & 17 \\ 22 & 10 & - 10 & - 22 \\ 17 & - 17 & - 17 & 17 \\ 10 & - 22 & 22 & - 10\end{matrix} ] .$$

The encoder performs forward 4×4, 4×8, 8×4, and 8×8 transforms on a data block D_{i×j} (having i rows and j columns) as follows:

\hat{D}_{4×4}=(T₄·D_{4×4}·T₄′)∘N_{4×4} for a 4×4 transform,

\hat{D}_{8×4}=(T₈·D_{8×4}·T₄′)∘N_{8×4} for a 8×4 transform,

\hat{D}_{4×8}=(T₄·D_{4×8}·T₈′)∘N_{4×8} for a 4×8 transform, and

\hat{D}_{8×8}=(T₈·D_{8×8}·T₈′)∘N_{8×8} for a 8×8 transform,

where · indicates a matrix multiplication, ∘N_{i×j} indicates a component-wise multiplication by a normalization factor, T′ indicates the inverse of the matrix T, and \hat{D}_{i×j} represents the transform coefficient block. The values of the normalization matrix N_{i×j} are given by:

N_{i×j}=cᵢ′·cⱼ,

where:

$${c}_{4} = ( \frac{8}{289} \frac{8}{292} \frac{8}{289} \frac{8}{292} ) , and$$

$${c}_{8} = ( \frac{8}{288} \frac{8}{289} \frac{8}{292} \frac{8}{289} \frac{8}{288} \frac{8}{289} \frac{8}{292} \frac{8}{289} ) .$$

To reconstruct a block R_{M×N} that approximates the block of original input values, the inverse transform in these implementations is performed as follows:

E_{M×N}=(D_{M×N}·T_{M}+4)>>3, and

R_{M×N}=(T_{N}′·E_{M×N}+C_{N}·I_{M}+64)>>7,

where M and N are 4 or 8, >> indicates a right bit shift, C₈=(0 0 0 0 1 1 1 1)′, C₄ is a zero column vector of length 4, and I_{M} is an M length row vector of ones. The reconstructed values are truncated after right shifting, hence the 4 and 64 for the effect of rounding.

Alternatively, the encoder uses other forward and inverse frequency transforms, for example, other integer approximations of DCT and IDCT.

2. Numerical Examples.

Suppose an 8×8 block of sample values includes 39 samples having values of 17 and 25 samples having values of 16. During encoding, the input values are scaled by 16 and converted to transform coefficients using an 8×8 frequency transform as shown the previous section. The original value of the DC coefficient for the block is 1889.77777, which is rounded up to 1890:

$$12 \times ( 12 \times ( 39 \times 17 \times 16 + 25 \times 16 \times 16 ) ) \times \frac{8}{288} \times \frac{8}{288} \approx 1890.$$

The transform coefficients for the block are quantized. Suppose the DC coefficient is quantized using a quantization parameter stepsize=2, and the applied quantization step size is 2×stepsize. Since the sample values were scaled up by a factor of 16, the quantization step size is also scaled up by a factor of 16. Quantization produces a quantization level of 29.53125, which is rounded up to 30: 1890÷(4×16)≈30. The AC coefficients are zero or quantized to zero, as the block is a DC-only block.

During reconstruction of the DC coefficient value, the quantization level for the DC coefficient is inverse quantized, applying the same quantization step size used in encoding, resulting in a reconstruction point value of 120. 30×4=120. (The scaling factor of 16 is not applied.)

To reconstruct the 8×8 block of sample values, an inverse frequency transform is performed on the reconstructed transform coefficients (specifically, the non-zero DC coefficient value and zero-value AC coefficients for the DC-only block). The sample values of the block are computed as 17.375, which is truncated to 17. (12×((12×120+4)>>3)+64)>>7≈17. Each of the reconstructed input values has the integer value expected for the block—17—since the average value for the input block was (39×17+25×16)/64=16.61.

In other cases, however, the reconstructed input values have a value different than expected. For example, suppose an 8×8 block of sample values includes 37 samples having values of 17 and 27 samples having values of 16. The average value for the input block is (37×17+27×16)/64=16.58, and one might expect the reconstructed sample values to have the integer value of 17. For some quantization step sizes, this is not the case.

During encoding, the input values are scaled by 16 and converted to transform coefficient values using the same 8×8 transform. The original value of the DC coefficient for the block is 1886.2222, which is rounded down to 1886:

$$12 \times ( 12 \times ( 37 \times 17 \times 16 + 27 \times 16 \times 16 ) ) \times \frac{8}{288} \times \frac{8}{288} \approx 1886.$$

The DC coefficient for the block is quantized, with stepsize=2 (and an applied quantization step size of 64), resulting in a quantization level of 29.46875, which is rounded down to 29: 1886÷(4×16)≈29. The AC coefficients are zero or quantized to zero, as the block is a DC-only block.

During reconstruction of the DC coefficient value, the quantization level for the DC coefficient is inverse quantized, resulting in a reconstruction point value of 116. From this DC value, the sample values of the block are computed as 16.8125, which is truncated to 16. (12×((12×16+4)>>3)+64)>>7≈16. Thus, each of the reconstructed values for the block—16—is different than expected value of 17. This happened because, of the two reconstruction point values closest to 1886 (which are 1856 and 1920), 1856 is closer to 1886, and 1856 and 1886 are on different sides of a transform bin boundary. Although an inverse frequency transform of a DC-only block with DC coefficient value 1856 results in sample values of 16, an inverse transform when the DC coefficient value is 1886 results in sample values of 17.

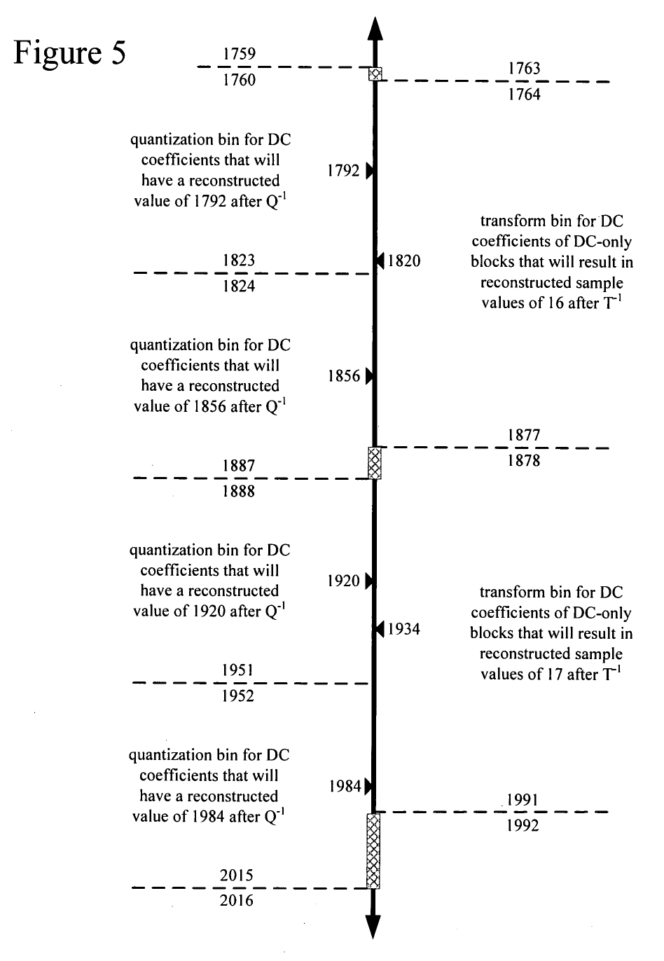

FIG. 5 illustrates some of the quantization bin boundaries and transform bin boundaries for this numerical example when stepsize=2 (and the applied quantization step size is 2×stepsize×16=64). In FIG. 5, the bins to the left of the vertical axis are quantization bins. For example, the “reconstruct to 1856” quantization bin includes DC coefficient values between 1824 and 1887 (inclusive) and has a reconstruction point value of 1856. One quantization bin boundary is between 1887 and 1888, the next is between 1951 and 1952, and so on. The quantization bins have a width of 64, which relates to the applied quantization step size.

In FIG. 5, the bins to the right of the vertical axis are transform bins. For example, the “reconstruct to 16” transform bin shown includes DC coefficient values between 1764 and 1877 (inclusive), and any DC coefficient value in the bin produces reconstructed input values of 16 when inverse transformed for a DC-only block. FIG. 5 shows transform bin boundaries between 1763 and 1764, between 1877 and 1878, and between 1991 and 1992. Two midpoints are shown for the transform bins: 1820 and 1934. The width of the transform bins is derived from the expansion in the forward transform:

$$12 \times 12 \times 64 \times 16 \times \frac{8}{288} \times \frac{8}{288} = \frac{1024}{9} .$$

The original DC coefficient value of 1886 is above the transform bin boundary between 1877 and 1878, but falls within the quantization bin at 1824 to 1887. As a result, the DC coefficient value is effectively shifted to the reconstruction point value 1856 (after quantization and inverse quantization), which is on the other side of the transform bin boundary.

In FIG. 5, because of the misalignment of transform bins and quantization bins, errors occur if a DC coefficient value is within one of the cross-hatched ranges on the axis. Mapping such a DC coefficient value to a closest reconstruction point value changes the transform bin. Stated differently, for such values, the closest center transform bin value is different for the original DC coefficient value and its nearest reconstruction point value.

B. Solutions.

Techniques and tools are described to improve quantization by biasing the quantization to account for relations between quantization bins and transform bins. For example, a video encoder biases quantization to compensate for mismatch between quantization bin boundaries and transform bin boundaries when quantizing DC coefficients of DC-only blocks. Alternatively, another type of encoder (e.g., audio encoder, image encoder) implements one or more of the techniques when quantizing DC coefficient values or other coefficient values.

Compensating for misalignment between quantization bins and transform bins helps provide better perceptual quality in some encoding scenarios. For DC-only blocks, mismatch compensation allows an encoder to adjust quantization levels such that the reconstructed input value for a block is closest to the average original input value for the block, where mismatch between quantization bin boundaries and transform bin boundaries would otherwise result in a reconstructed input value farther away from the original average.

Or, biasing quantization can help reduce or even avoid blocking artifacts that are not caused by boundary mismatches. For example, suppose a relatively flat region includes blocks that each have a mix of 16-value samples and 17-value samples, where the averages for the blocks vary from 16.45 to 16.55. When encoded as DC-only blocks and quantized with mismatch compensation, some blocks may be reconstructed as 17-value blocks while others are reconstructed as 16-value blocks. If a user is given some control over the threshold for quantization bias, however, the user can set the threshold so that all blocks are 17-value blocks or all blocks are 16-value blocks. Since reconstructing the fine texture for the blocks is not possible given encoding constraints, reconstructing the blocks to have the same sample values can be preferable to reconstructing the blocks to have different sample values.

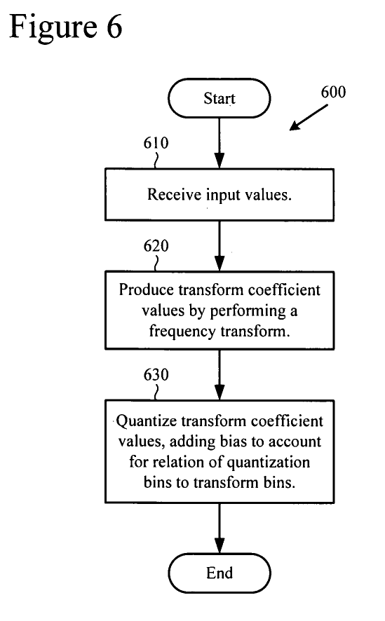

FIG. 6 shows a generalized technique (600) for using quantization bias that accounts for relations between quantization bins and transform bins. The encoder receives (610) a set of input values. For example, the input values are sample values or residual values for an 8×8, 8×4, 4×8 or 4×4 block. Alternatively, the input values are for a different size of block and/or different type of input. The encoder produces (620) transform coefficient values by performing a frequency transform. In some implementations, the encoder performs a frequency transform on the input values as described in section III.A.1. Alternatively, the encoder performs a different transform and/or gets the DC coefficient value from a different module.

The encoder then quantizes (630) the transform coefficient values. For example, the encoder uses uniform scalar quantization or some other type of quantization. In doing so, the encoder sets a quantization level for a first transform coefficient value (e.g., DC coefficient value) of the transform coefficients. When setting the quantization level, the encoder biases quantization in a way that accounts for the relations between quantization bins and transform bins. For example, the encoder follows one of the three approaches described below. In the first approach, during quantization, an encoder detects boundary mismatch problems using static criteria and compensates for any detected mismatch problems “on the fly.” In the second approach, an encoder uses a predetermined offset table that indicates offsets for different DC coefficient values to compensate for misalignment between quantization bins and transform bins. In the third approach, an encoder uses adjustable thresholds to control the quantization bias. Alternatively, the encoder uses another mechanism to bias quantization.

Each of FIGS. 6, 7, 8, 9 and 11 shows a technique (600, 700, 800, 900 and 1100) that can be performed by a video encoder such as the one shown in FIG. 4. Alternatively, another encoder or other tool performs the technique (600, 700, 800, 900 and 1100). Moreover, while each of the techniques (600, 700, 800, 900 and 1100) is shown as being performed for a single block of input values, in practice the technique is typically embedded within other encoding processes for quantization and/or rate control. The technique may be performed once for a block or may be performed iteratively during evaluation of different quantization step sizes for the same block.

1. On-the-Fly Mismatch Compensation Using Static Criteria.

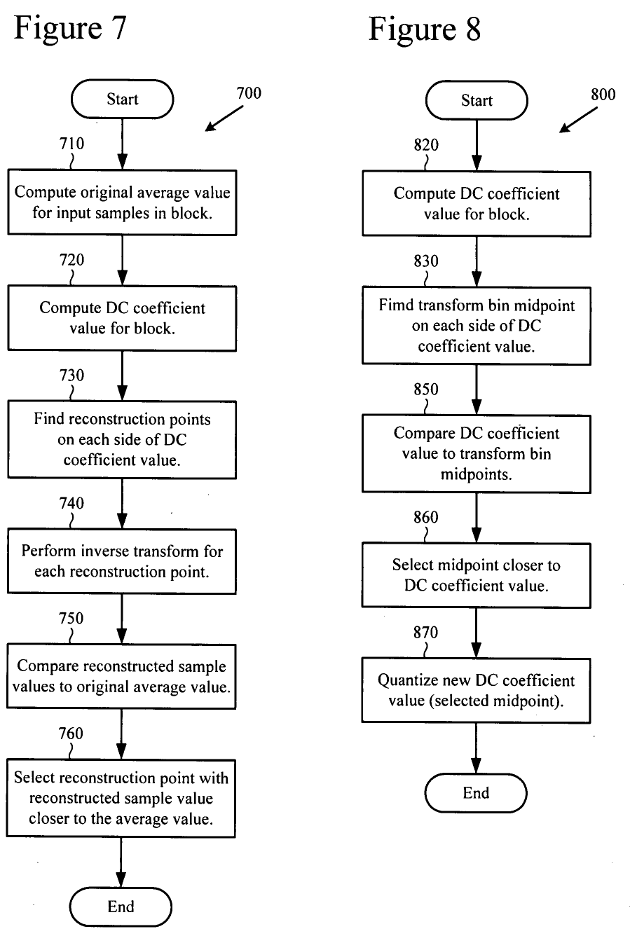

In some embodiments, an encoder detects mismatch problems using static criteria and dynamically compensates for any detected mismatch problems. The encoder can detect the mismatch problems, for example, using sample domain comparisons or transform domain comparisons. FIGS. 7 and 8 show techniques (700, 800) for mismatch compensation using sample domain comparisons and transform domain comparisons, respectively, in quantization of DC coefficient values.

a. Sample-Domain Comparisons.

With reference to FIG. 7, the encoder computes (710) or otherwise gets the average input value x̅ for the input values in the block, which can be sample values or residual values for a picture, for example. The encoder also computes (720) or otherwise gets the DC coefficient value for the block of input values.

The encoder finds (730) the two reconstruction point values next to the DC coefficient value. For each of the two reconstruction point values, the encoder performs (740) an inverse frequency transform, producing a reconstructed value x′ for the samples in the block, or the encoder otherwise computes the reconstructed value x′ for the reconstruction point value.

For each of the two reconstruction point values, the encoder compares (750) the reconstructed value x′ for the samples of the block to the original average value x̅. From these sample-domain comparisons, the encoder selects (760) the reconstruction point value whose x′ value is closer to the average value x̅. The encoder uses the quantization level for the selected reconstruction point value to represent the DC coefficient for the block.

With reference to FIG. 5, if the DC coefficient value is 1886, the encoder finds the reconstruction point values 1856 and 1920. For the DC coefficient value 1886, the original average pixel value is 16.57. The reconstructed sample values are 16 and 17 for the reconstruction point values 1856 and 1920, respectively. Since 16.57 is closer to 17 than it is to 16, the encoder uses the quantization level—30—for the reconstruction point value 1920.

b. Transform-Domain Comparisons.

In a mismatch compensation approach with transform-domain comparisons, the encoder computes a DC coefficient value. Before the DC coefficient value is quantized, the encoder shifts the DC coefficient value to the midpoint of the transform bin that includes the DC coefficient value. The shifted DC coefficient value (now the transform bin midpoint value) is then quantized. One way to find the transform bin that includes the DC coefficient value is to compare the DC coefficient value with the two transform bin midpoints on opposite sides of the DC coefficient value.

With reference to FIG. 8, the encoder computes (820) or otherwise gets the DC coefficient value for the block of input values. The encoder finds (830) the transform bin midpoints on the respective sides of the DC coefficient value. For each of the two transform bin midpoints, the encoder compares (850) the transform bin midpoint to the DC coefficient value. From these transform-domain comparisons, the encoder selects (860) the transform bin midpoint value closer to the DC coefficient value. The encoder then uses (870) the transform bin midpoint for the DC coefficient value, quantizing the transform bin midpoint value by replacing it with a quantization level to represent the DC coefficient for the block.

For example, with reference to FIG. 5, if the DC coefficient value is 1886, the encoder finds the transform bin midpoints 1820 and 1934, which are the centers of the “reconstruct to 16” and “reconstruct to 17” transform bins, respectively. The encoder compares 1886 to 1820 and 1934 and selects 1934 as being closer to 1886. The DC coefficient value is effectively shifted to the middle of the transform bin that includes it, which is the “reconstruct to 17” transform bin, and the transform bin midpoint 1934 is quantized and coded.

2. Mismatch Compensation with Predetermined Offset Tables.

In some embodiments, an encoder uses an offset table when compensating for mismatch between transform bin boundaries and quantization bin boundaries for quantization. The offset table can be precomputed and reused in different encoding sessions to speed up the quantization process. Compared to the “on-the-fly” mismatch compensation described above, using lookup operations with an offset table is typically faster and has lower complexity, but it also consumes additional storage and memory resources for the offset table. In some implementations, the size of the offset table is reduced by recognizing and exploiting periodic patterns in the offsets.

a. Using Offset Tables.

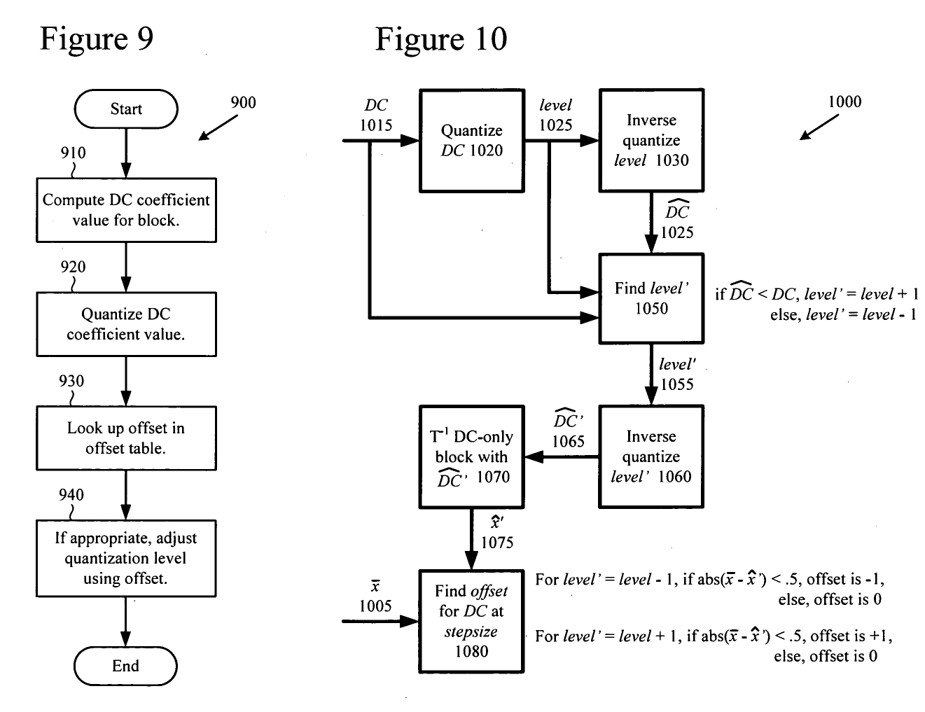

FIG. 9 shows a technique (900) for mismatch compensation using an offset table in quantization of DC coefficient values. The encoder computes (910) or otherwise gets the DC coefficient value for the block of input values. The encoder then quantizes (920) the DC coefficient value. For example, the encoder performs uniform scalar quantization on the DC coefficient value.

Next, the encoder looks up (930) an offset for the DC coefficient value and, if appropriate, adjusts (940) the quantization level using the offset table. For example, the offset table is created as described below with reference to FIG. 10. Alternatively, the offset table is created using some other technique. In some cases, the offset for the DC coefficient value is zero, and the adjustment (940) can be skipped.

Thus, in the technique (900), a mismatch compensation phase is added to the normal quantization process for the DC coefficient value. In some implementations, the encoder looks up the offset and adds it to the quantization level level_{old} as follows.

level_{new}=level_{old}+offset_{8×8}[stepsize][DC];

where offset_{8×8} is a two-dimensional offset table computed for a particular 8×8 frequency transform. The offset table is indexed by quantization step size and DC coefficient value. In these implementations, different offsets are computed for each DC coefficient for each possible quantization step size.

The preceding examples of offset tables store offsets to be applied to quantization levels, where the offsets are indexed by DC coefficient value. Alternatively, an offset table stores a different kind of offsets. For example, an offset table stores offsets to be applied to DC coefficient values to reach an appropriate transform bin midpoint, where the offsets are indexed by DC coefficient value. Moreover, although the offset tables described herein are typically used for mismatch compensation, different offsets can be computed for another purpose, for example, to bias quantization of DC coefficients more aggressively towards zero and thereby reduce blocking artifacts that often occur when dithered content is encoded as DC-only blocks.

b. Preparing Offset Tables.

In some embodiments, an encoder or other tool computes offsets off-line and stores the offsets in one or more offset tables for reuse during encoding. Different offset tables are typically computed for different size transforms. For example, the encoder or other tool prepares different offset tables for 8×8, 8×4, 4×8 and 4×4 transforms that the encoder might use. An offset table can be organized or split into multiple tables, one for each possible quantization step size.

FIG. 10 shows an example tool (1000) that computes values of offset tables used for mismatch compensation of DC coefficients. For example, the tool is a video encoder such as the one shown in FIG. 4 or other encoder.

In particular, FIG. 10 shows stages of computing an offset for a given possible DC coefficient value DC (1015) at a given quantization step size stepsize. For DC (1015), quantization (1020) produces a quantization level (1025) by applying stepsize. The level (1025) is inverse quantized (1030), producing a reconstructed DC coefficient (1025).

The tool then finds (1050) an adjusted quantization level (1055), level′, to be used in the offset determination process. The value of level′ is selected so that level′ and level have reconstruction points on opposite sides of DC (1015). For example, if the reconstructed DC coefficient (1025) is less than DC (1015), then level′ is level+1. Otherwise, level′ is level−1.

The tool inverse quantizes (1060) level′ (1055), producing a reconstruction point (1065) for the adjusted level. The tool inverse transforms (1070) a DC-only block that has the level′ reconstruction point (1065) for its DC coefficient value, producing a reconstructed input value (1075) for the block, shown as \hat{x}′ in FIG. 10. Considering the reconstructed input value \hat{x}′ (1075) and the average x̅ (1005) of the original input values (in floating point format), the tool finds (1080) the offset for DC (1015) at stepsize.

Suppose the adjusted level (1055) is above the initial level (1025) (i.e., level′ is level+1). If the absolute difference between the reconstructed input value \hat{x}′ (1075) and the original input average x̅ (1005) is less than a threshold (for mismatch compensation, set at 0.5 to be halfway between transform bin midpoints), the offset for DC at stepsize is +1. Otherwise, the offset is 0.

When the adjusted level (1055) is below the initial level (1025) (i.e., level′ is level−1), the offset is −1 or 0. If the absolute difference between \hat{x}′ (1075) and x̅ (1005) is less than the threshold, the offset for DC at stepsize is −1. Otherwise, the offset is 0.

For example, referring again to FIG. 5, if DC=1886 and stepsize=2 (for an applied quantization step size of 2×2×16=64 after factoring in the scaling factor of 16), level=29 and the reconstructed DC coefficient is 1856. Since 1856 is less than DC, level′ is 29+1=30. Note the reconstruction points for level and level′ are 1856 and 1920, and these points are on opposite sides of 1886. When a DC-only block with the DC value of 1920 is inverse transformed, the reconstructed sample value \hat{x}′=17 is produced. Since the average of original input values x̅=16.57, the absolute difference between x̅ and \hat{x}′ is |16.57−17|=0.43. This is less than 0.5, so the offset is +1 for DC=1886 at stepsize=2. In summary, DC=1886 is quantized to a level=29 that has a reconstruction point of 1856, which is in a different transform bin from 1886. The offset of +1 is applied, and a DC coefficient value of 1886 is represented with a quantization level of 30 whose reconstruction point is 1920, which is in the same transform bin as 1886.

As another FIG. 5 example, suppose DC=1890 and x̅=16.61. For stepsize=2, level=30 (reconstruction point 1920), level′=29 (reconstruction point 1856), and \hat{x}′=16. Since the absolute difference between x̅ and \hat{x}′, |16.61−16|=0.61, is greater than 0.5, the offset is 0 for DC=1890 at stepsize=2. As FIG. 5 shows, this is not surprising since 1890 and 1920 are already in the same transform bin.

Returning to FIG. 10, the tool continues by computing the offset for another DC coefficient value (1015) for the same quantization step size. Or, if offsets have been computed for all of the possible DC coefficient values at a given step size, the tool starts computing offsets for the possible DC coefficient values at another quantization step size. This continues until offsets are computed for each of the quantization step sizes used.

The tool organizes the offsets into lookup tables. For example, the tool organizes the offsets in a three-dimensional table with indices for transform size, quantization step size, and DC coefficient value. Or, the tool organizes the offsets into different tables for different transform sizes, with each table having indices for step size and DC coefficient value. Or, the tool organizes the offsets into different tables for different transform sizes and quantization step sizes, with each table having an index for DC coefficient value.

c. Reducing Offset Table Size.

For many types of frequency transforms, the offsets for possible DC coefficient values at a given quantization step size exhibit a periodic pattern. The encoder can reduce table size by storing only the offset values for one period of the pattern. For example, for one implementation of the 8×8 transform described in section III.A, the pattern of −1, 0 and +1 offsets repeats every 1024 values for the DC coefficient. During encoding, the encoder looks up the offset and adds it to the quantization level level_{old} as follows:

level_{new}=level_{old}+offset_{8×8}[stepsize][(DC−DCₘᵢₙᵢₘᵤₘ)&1023],

where offset_{8×8} has 1024 offsets per quantization step size. The minimum allowed DC coefficient value, DCₘᵢₙᵢₘᵤₘ, and bit mask operation (& 1023) are used to find the correct position in the periodic pattern for DC. The index is given by (DC−DCₘᵢₙᵢₘᵤₘ) & 1023, which provides the least significant 10 bits of the difference DC−DCₘᵢₙᵢₘᵤₘ.

In one example table, offset_{8×8}[2][1024] has offsets of 0 in each position except the following, in which the offset is 1 or −1:
offsets of +1 for the following indices: {101, 102, 103, 104, 105, 106, 107, 108, 109, 110, 111, 112, 329, 330, 331, 332, 333, 334, 335, 336, 337, 556, 557, 558, 559, 560, 784, 785}
offsets of −1 for the following indices: {210, 211, 212, 213, 214, 433, 434, 435, 436, 437, 438, 439, 440, 441, 658, 659, 660, 661, 662, 663, 664, 665, 666, 667, 668, 669, 881, 882, 883, 884, 885, 886, 887, 888, 889, 890, 891, 892, 893, 894, 895, 896, 1009, 1010}

When the offset tables are computed, periodic patterns can be detected by software analysis of the offsets or by visual analysis of the offset patterns by a developer. Alternatively, the encoder or other tool uses a different mechanism to exploit periodicity in offset values to reduce lookup table size. Or, the offset tables are kept at full size.

3. Quantization Bias with Adjustable Boundaries.

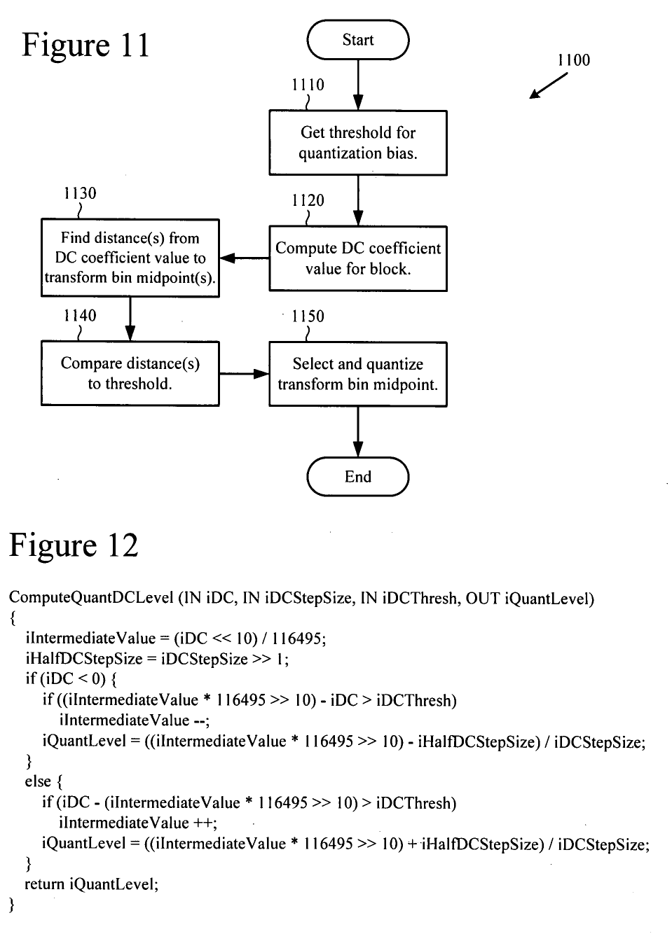

There are many different approaches to biasing quantization in ways that account for the relations between quantization bins and transform bins. Some approaches use predetermined offsets (e.g., as in FIG. 9) whereas others compute adjustments on the fly (e.g., as in FIGS. 7, 8 and 11). Some approaches use static criteria for deciding what to adjust (e.g., as in FIGS. 7-9) while others use adjustable criteria (e.g., as in FIG. 11). Finally, while some approaches use quantization bias for mismatch compensation (e.g., as in FIGS. 7-9), others more generally bias quantization for any purpose (e.g., as in FIG. 11).

Using predetermined adjustments (as in the offset tables of FIGS. 9 and 10) has advantages but also has a few drawbacks. During encoding, biasing quantization using the predetermined adjustments is quick and simple. On the other hand, to be prepared for any possible DC coefficient value at any possible quantization step size, many adjustments are determined. Aside from the effort involved in determining the adjustments, storing the adjustments (e.g., in offset tables) can consume significant storage and memory resources. Computing adjustments on the fly (as in FIGS. 7, 8 and 11) saves storage and memory resources, but is more computationally complex at run time.

Using static criteria for deciding what to adjust (e.g., as in FIGS. 7-9) works if the purpose of making adjustments is unlikely to change. For example, for mismatch compensation, static criteria can be used to compute offsets or other predetermined adjustments, or static criteria can be used to set thresholds for on-the-fly decisions. The tables in the FIG. 10 example are computed with a particular fixed threshold of 0.5. Effectively, this compensates for mismatch in a DC-only block by favoring a reconstructed input value closest to the average input value of the original block. Similarly, the examples of FIGS. 7 and 8 use a static “closer to” threshold in comparisons. Using static criteria simplifies implementation, but static criteria are by definition inflexible. In some scenarios, allowing adjustment of thresholds can help reduce perceptual artifacts that might result when a static threshold is used.

Similarly, mismatch compensation (e.g., as in FIGS. 7-9) improves quality in some scenarios but not others. Suppose it is not always desirable to have the reconstructed input value be the closest to the original average input value. For example, for a relatively flat image region that contains a mix of samples with values of 16 and 17, suppose some blocks have an average value of 16.45 and others have an average value of 16.55. If a static threshold is used for mismatch compensation during quantization for DC-only blocks, the resulting region will have visible blocking artifacts where all-16 blocks transition to all-17 blocks. By using an adjustable threshold to bias quantization, the encoder can adjust quantization for DC coefficients of DC-only blocks, so that reconstructed sample values are more uniform from block-to-block but not necessarily closest to the original average pixel values in each block. For example, for the region that contains some blocks with an average value of 16.45 and others with an average value of 16.55, the threshold is adjusted so that the blocks in the region are reconstructed as all-17 blocks. Or, the threshold is adjusted so that the blocks in the region are reconstructed as all-16 blocks.

Thus, in some embodiments, an encoder uses adjustable thresholds to bias quantization. For example, the encoder adjusts a threshold that effectively changes how DC coefficient values are classified in transform bins for purposes of quantization decisions for DC-only blocks. Whereas the static threshold examples described herein account for misalignment between transform bin boundaries and quantization bin boundaries, the adjustable threshold more generally allows control over the bias of quantization for DC coefficients in DC-only blocks.

In some implementations, the user is allowed to vary the threshold during encoding or re-encoding to react to blocking artifacts that the user perceives or expects. In general, an on/off control for mismatch compensation can be exposed to a user as a command line option, encoding session wizard option, or other control no matter the type of quantization bias used. When bias thresholds are adjustable, another level of control can be exposed to the user. For example, the user is allowed to control thresholds for quantization bias for DC-only blocks on a scene-by-scene basis, picture-by-picture basis, or some other basis. In addition to setting a threshold parameter, the user can be allowed to define regions of an image in which the threshold parameter is used for quantization for DC-only blocks. In other implementations, the encoder automatically detects blocking artifacts between DC-only blocks and automatically adjusts the threshold to reduce differences between the blocks.

a. Using Adjustable Thresholds.

FIG. 11 shows a technique (1100) for biasing quantization of DC coefficient values using adjustable thresholds. The encoder gets (1110) a threshold for compensation. For example, a user specifies the threshold using a command line option, encoding session wizard, or other control, or the threshold is set as part of installation of an encoder, or the threshold is dynamically updated by the user or encoder during encoding.

Next, the encoder computes (1120) or otherwise gets the DC coefficient value for the block and finds (1130) the distance between one or more transform bin midpoints and the DC coefficient value for the block. In some implementations, the encoder finds just the distance between the DC coefficient value and the transform bin midpoint lower than it. In other implementations, the encoder finds the distances between the DC coefficient value and the transform bin midpoint on each side of the DC coefficient value.

The encoder compares (1140) the distance(s) to the threshold. The encoder selects (1150) one of the transform bin midpoints and quantizes the selected midpoint, producing a quantization level to be used for the DC coefficient value. For example, the encoder determines if the distance between the DC coefficient value and transform bin midpoint lower than it is less than the threshold. If so, the midpoint is used for the DC coefficient value. Otherwise, the transform bin midpoint higher than the DC coefficient value is used for the DC coefficient value.

In this way, the encoder biases quantization of the DC coefficient value in a way that accounts for the relations between quantization bins and transform bins. The encoder shifts the DC coefficient value to the middle of a transform bin, selected depending on the threshold, and performs quantization. The resulting quantization level depends on the quantization bin that includes the transform bin midpoint.

b. Example Pseudocode.

FIG. 12 shows pseudocode illustrating one implementation of bias compensation using adjustable thresholds. In this implementation, the routine ComputeQuantDCLevel accepts three input parameters: iDC, iDCStepSize and iDCThresh. iDC is the DC coefficient value for a DC-only block, computed separately in the encoder. iDCStepSize is the quantization step size applied for the DC coefficient. iDCThresh is the adjustable threshold, provided by the user or a module of the encoder. ComputeQuantDCLevel returns an output parameter iQuantLevel, which is the quantized DC coefficient level, biased according to the adjustable threshold.

To start, the routine computes an intermediate input-domain value from iDC. The intermediate value is an integer truncated such that it indicates the reconstructed value for the adjacent transform bin midpoint closer to zero than iDC. For example, if iDC=1886, the value of 16.58 is truncated to 16 (the reconstructed input value for the transform bin midpoint 1820).

If iDC is negative, the difference between the transform bin midpoint closer to zero and iDC is computed. If the difference is greater than iDCThresh, the intermediate value is decremented such that it is the reconstructed value for the adjacent transform bin midpoint farther from zero than iDC. The transform bin midpoint for the intermediate value is computed and then quantized according to iDCStepSize. For example, if iDC=−1886, and the adjacent transform bin midpoint closer to zero is −1820 (for an intermediate value of −16), the difference is −1820-−1886=66. If 66 is greater than iDCThresh, the intermediate value is changed to −17. Otherwise, the intermediate value stays at −16. When iDCStepSize=64 and iDCThresh=62, then iQuantLevel=−30, after truncation: ((−17×116495>>10)−32)/64=−30.

If iDC is not negative, the difference between iDC and the transform bin midpoint closer to zero is computed. If the difference is greater than iDCThresh, the intermediate value is incremented such that it is the reconstructed value for the adjacent transform bin midpoint farther from zero than iDC. The transform bin midpoint for the intermediate value is computed and then quantized according to iDCStepSize. For example, if iDC=1886, and the adjacent transform bin midpoint closer to zero is 1820 (for an intermediate value of 16), the difference is 1886−1820=66. If 66 is greater than iDCThresh, the intermediate value is changed to 17. Otherwise, the intermediate value stays at 16. If iDCStepSize=64 and iDCThresh=62, then iQuantLevel=30, after truncation: ((17×116495>>10)+32)/64=30.

As another example, if iDC=1876, the adjacent transform bin midpoint closer to zero is 1820 and the intermediate value is initially 16. If iDCThresh=62, the difference of 56 is not greater than iDCThresh, and the intermediate value is unchanged. iQuantLevel=28, after truncation: ((16×116495>>10)+32)/64=28. In this example, despite the fact that 1876 falls within the quantization bin for the quantization level 29, the iDC is assigned quantization level 28. This is because the selected transform bin midpoint, 1820, is within the quantization bin for the quantization level 28.

In the pseudocode of FIG. 12, the factor 116495/1024 approximates the length of one transform bin (about 113.78) for the frequency transform. For a different frequency transform, the factor changes according the transform bin width for the transform.

As noted above, in FIG. 12, iDCThresh specifies how to bias the quantization process. When iDCThresh=57 (roughly half of 113.78), the quantization bias effectively performs mismatch compensation. So, when iDCThresh=57, the reconstructed input value is the one closest to the average input value of the original block. On the other hand, if iDCThresh is set to a number other than 57, the encoder will bias iDC toward either the bigger neighboring reconstruction point (if iDCThresh>57) or the smaller one (if iDCThresh<57). In one implementation, the default setting for iDCThresh is 75, which typically helps reduce blocking artifacts for dithered content, and the setting can vary dynamically during encoding. In other implementations, iDCThresh has a different default setting and/or does not vary dynamically during encoding.

### IV. Extensions.

Although the techniques and tools described herein are in places presented in the context of video encoding, quantization bias (including mismatch compensation) for DC-only blocks can be used in other types of encoders, for example audio encoders and still image encoders. Moreover, aside from DC-only blocks, quantization bias (including mismatch compensation) can be used for DC coefficients of blocks that have one or more non-zero AC coefficients.

The forward transforms and inverse transforms described herein are non-limiting. The described techniques and tools can be applied with other transforms, for example, other integer-based transforms.

Having described and illustrated the principles of our invention with reference to various embodiments, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method comprising:
receiving plural input values;
producing one or more transform coefficient values by performing a frequency transform on the plural input values; and
quantizing the one or more transform coefficient values, wherein the quantizing includes setting a quantization level for a first transform coefficient value of the one or more transform coefficient values, and wherein the setting uses quantization bias that accounts for relations between quantization bins and transform bins.

2. The method of claim 1 wherein the plural input values have an average value, and wherein the quantization bias accounts for mismatch between quantization bin boundaries and transform bin boundaries to make a reconstructed input value for the plural input values closer to the average value.

3. The method of claim 1 wherein the plural input values are sample values or residual values for a block of a video image, and wherein the first transform coefficient value is a DC coefficient value.

4. The method of claim 3 further comprising, after the frequency transform but before the quantizing, evaluating the one or more transform coefficient values and classifying the block as a DC-only block.

5. The method of claim 1 further comprising:
entropy encoding results of the quantizing; and
outputting results of the entropy encoding in a video bit stream.

6. The method of claim 1 wherein the setting the quantization level includes:
determining an initial value for the quantization level based upon a reconstruction point value that is closest to the first transform coefficient value;
determining an offset value that depends on the first transform coefficient value and mismatch between quantization bin boundaries and transform bin boundaries; and
adjusting the initial value by the offset value.

7. The method of claim 6 wherein a lookup table records plural offset values to compensate for the mismatch.

8. The method of claim 7 wherein the plural offset values exhibit a periodic pattern across allowable transform coefficient values, the lookup table having its size reduced by exploiting the periodic pattern.

9. The method of claim 1 wherein an adjustable parameter controls extent of the quantization bias, the adjustable parameter being adjustable by a user or by the encoder.

10. The method of claim 9 wherein the adjustable parameter is set to compensate for mismatch between quantization bin boundaries and transform bin boundaries.

11. The method of claim 9 wherein the adjustable parameter is adjusted during encoding to reduce blocking artifacts.

12. The method of claim 1 wherein the setting the quantization level comprises:
determining a characteristic value for the first transform coefficient value by:
determining a reconstructed value for the first transform coefficient value;
determining a transform bin midpoint for the reconstructed value;
determining a difference between the first transform coefficient value and the transform bin midpoint;
comparing the difference to a threshold;
if the difference satisfies the threshold, adjusted the reconstructed value; and
using the reconstructed value to compute the characteristic value;
quantizing the characteristic value to produce the quantization level.

13. The method of claim 12 wherein the threshold is adjustable, and wherein adjusting the threshold changes the quantization bias.

14. The method of claim 1 wherein the setting the quantization level comprises:
determining a characteristic value for the first transform coefficient value by:
comparing the first transform coefficient value to plural different characteristic values for plural different transform bins; and
selecting the characteristic value from among the plural different characteristic values as being closest to the first transform coefficient value; and
quantizing the characteristic value to produce the quantization level.

15. An encoder comprising:
a frequency transformer adapted to perform frequency transforms on plural input values, thereby producing plural transform coefficient values; and
a quantizer adapted to quantize the plural transform coefficient values by performing operations that include setting a first quantization level for a first transform coefficient value of the plural transform coefficient values, wherein the setting the first quantization level uses quantization bias that accounts for relations between quantization bins and transform bins.

16. The encoder of claim 15 wherein the plural input values are for blocks of video images, and wherein the first transform coefficient value is a DC coefficient value for a DC-only block among the plural blocks.

17. The encoder of claim 15 wherein the setting the first quantization level includes:
determining an initial value for the first quantization level based upon a reconstruction point value closest to the first transform coefficient value;
determining an offset value that depends on the first transform coefficient value and mismatch between quantization bin boundaries and transform bin boundaries; and
adjusting the initial value by the offset value.

18. The encoder of claim 15 wherein the encoder sets an adjustable parameter to control extent of the quantization bias.

19. The encoder of claim 15 wherein the setting the first quantization level includes:
determining a characteristic value based at least in part upon an adjustable threshold that changes the quantization bias; and
quantizing the characteristic value.

20. A video encoder comprising:
means for producing transform coefficient values by performing frequency transforms on input values for blocks of video images; and
means for quantizing the transform coefficient values, wherein the quantizing includes setting a quantization level for a DC transform coefficient value of the transform coefficient values, the DC transform coefficient value being for a DC-only block among the blocks, and wherein the setting accounts for mismatch between quantization bin boundaries and transform bin boundaries.
